(19) United States
(12) Patent Application Publication
(10) Pub. No.: US 2020/0229451 A1
(43) Pub. Date: Jul. 23, 2020

(54) METHOD OF MAKING A WAFFLE

(71) Applicant: Tiffiney Ericksen, San Bernardino, CA (US)

(72) Inventor: Tiffiney Ericksen, San Bernardino, CA (US)

(21) Appl. No.: 16/252,547

(22) Filed: Jan. 18, 2019

(51) Int. Cl. A21D 13/36; A21D 13/45; A21D 13/24; A21D 13/48

(52) U.S. Cl. CPC A21D 13/36; A21D 13/48; A21D 13/24; A21D 13/45

(57) ABSTRACT

A method of making a waffle for use with ice-cream, frozen yogurt, and similar frozen desserts structured and arranged to have a playful and unique shapes and a wide variety of fresh savory flavors including real strawberry, blueberry, banana, and cookie and candy bar flavors to please consumers by adding a wide range of delicious offerings to their choices of desserts.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to methods for flavor application to comestibles and more specifically relates to a method of making a waffle for use with ice-cream, frozen yogurt, and similar frozen desserts structured and arranged to have a playful and unique shapes and a wide variety of fresh savory flavors including real strawberry, blueberry, banana, and cookie and candy bar flavors to please consumers by adding a wide range of delicious offerings to their choices of desserts and snacks.

### 2. Description of the Related Art

According to International Dairy Foods Association, the average American consumes almost 22 pounds of ice cream per year. That's a lot of ice-cream, and requires a lot of ice-cream cones.

A waffle is a dish made from leavened batter or dough that is cooked between two plates that are patterned to give a characteristic size, shape, and surface impression. There are many variations based on the type of waffle iron and recipe used. Waffles are eaten throughout the world, particularly in Belgium, which has over a dozen regional varieties. Waffles may be made fresh or simply heated after having been commercially precooked and frozen.

An ice cream cone is a dry, cone-shaped pastry, usually made of a wafer similar in texture to a waffle, which enables ice cream to be held in the hand and eaten without a bowl or spoon. Various types of ice cream cones include wafer (or cake) cones, waffle cones, and sugar cones. Many styles of cones are made, including pretzel cones and chocolate-coated cones. A variety of double wafer cone exists that allows two scoops of ice cream to be served side by side. Wafer cones are sometimes made with a flat bottom instead of a pointed, conical shape, enabling the ice cream and “cone” to stand upright on a surface without support. These types of wafer cones are often branded as “cups.” Unfortunately waffle bowls are one flavor and typically only come in either a bowl or cone shape.

Various attempts have been made to solve problems found in methods or apparatuses for flavor application art. Among these are found in: U.S. Publication No. 20060078652 to Rhudy Phillips; U.S. Pat. No. 4,505,220 to Bank et al; U.S. Pat. No. 3,192,891 to Elmore F Maehl. This prior art is representative of methods or apparatuses for flavor application.

Ideally, a method of making a waffle for use with ice-cream, frozen yogurt, and similar frozen desserts should be user-friendly and safe in-use and yet would operate reliably and be manufactured at a modest expense. Thus, a need exists for a method of making a waffle for use with ice-cream, frozen yogurt, and similar frozen desserts structured and arranged to have a playful and unique shapes and a wide variety of fresh savory flavors including real strawberry, blueberry, banana, and cookie and candy bar flavors to please consumers by adding a wide range of delicious offerings to their choices of desserts and snacks and to avoid the above-mentioned problems.

### BRIEF SUMMARY OF THE INVENTION

In view of the foregoing disadvantages inherent in the known methods for flavor application to comestibles art, the present invention provides a novel Method of Making A Waffle for use with ice-cream, frozen yogurt, and similar frozen desserts. The general purpose of the present invention, which will be described subsequently in greater detail is to provide a method of making a waffle for use with ice-cream, frozen yogurt, and similar frozen desserts structured and arranged to have a playful and unique shapes and a wide variety of fresh savory flavors including real strawberry, blueberry, banana, and cookie and candy bar flavors to please consumers by adding a wide range of delicious offerings to their choices of desserts

A method of making a waffle comprising the steps of: step one providing ⅔ cup of flour; step two providing ½ teaspoon of salt; step three providing 2 eggs; step four providing ½ cup of sugar; step five providing 4 tablespoons of butter; step six providing ¼ cup of milk; step seven stirring the salt and flour together; step eight whisking the eggs and sugar together; step nine stirring the salt and flour with the eggs and sugar and with the butter and milk into a smooth, consistent mix; step ten adding a flavoring to the mix; step eleven cooking the mix in a waffle iron to form a waffle; and step twelve molding the waffle into a desired shape adapted to hold a food product therein.

The present invention holds significant improvements and serves as a Method ff Making A Waffle for use with ice-cream, frozen yogurt, and similar frozen desserts. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Method of Making A Waffle for use with ice-cream, frozen yogurt, and similar frozen desserts, constructed and operative according to the teachings of the present invention.

FIG. 1 is a flowchart illustrating a Method of Making A Waffle for use with ice-cream, frozen yogurt, and similar frozen desserts according to an embodiment of the present invention of FIG. 1.

FIG. 2 is a perspective view illustrating a mold used to shape a waffle for use with ice-cream, frozen yogurt, and similar frozen desserts according to an embodiment of the present invention of FIG. 1.

FIG. 3 is a perspective view illustrating a waffle shaped as a round-shaped bowl in an in-use condition for use with ice-cream, frozen yogurt, and similar frozen desserts according to an embodiment of the present invention of FIG. 1.

FIG. 4 is a perspective view illustrating a waffle shaped as a cone having words formed by icing on an outer surface for use with ice-cream, frozen yogurt, and similar frozen desserts according to an embodiment of the present invention of FIG. 1.

FIG. 5 is a perspective view illustrating a waffle shaped as a heart for use with ice-cream, frozen yogurt, and similar frozen desserts according to an embodiment of the present invention of FIG. 1.

FIG. 6 is a perspective view illustrating a waffle shaped as a football having pattern formed by icing on an outer surface for use with ice-cream, frozen yogurt, and similar frozen desserts according to an embodiment of the present invention of FIG. 1.

FIG. 7 is a perspective view illustrating a waffle shaped as a flower having a design formed by icing on an outer surface for use with ice-cream, frozen yogurt, and similar frozen desserts according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a method for flavor application to comestibles and more particularly to a method of making a waffle for use with ice-cream, frozen yogurt, and similar frozen desserts structured and arranged to have a playful and unique shapes and a wide variety of fresh savory flavors including real strawberry, blueberry, banana, and cookie and candy bar flavors to please consumers by adding a wide range of delicious offerings to their choices of desserts.

Generally speaking, the Method of Making A Waffle for use with ice-cream, frozen yogurt, and similar frozen desserts will be preferably offered in four shapes: a traditional cone; a heart-shaped “bowl”; a football-shaped “bowl”; a “flower-shaped” bowl; and a round “bowl”. Shapes may also vary. To this delectable homemade waffle cone mix are then added a variety of fresh flavorings—crumbled Oreo® cookies; fresh or frozen strawberries or blueberries; bananas; Reese's Pieces® chopped walnuts or cashews—and many more potential and delicious flavoring ingredients. The resultant mix is then cooked in a waffle-iron, and molded, using a cone-mold and the three separate “bowl” molds, into the finished the Method of Making A Waffle for use with ice-cream, frozen yogurt, and similar frozen desserts, which may then be further decorated and enhanced with twirls and patterns of icing. A commercial-sized production process would utilize the same fresh ingredients in the same proportions as the inventor has used in her kitchen, but on a much larger scale.

The Method of Making A Waffle for use with ice-cream, frozen yogurt, and similar frozen desserts, then, would add greatly to consumers' enjoyment of ice-cream, frozen yogurt, and similar frozen desserts—First, by adding a wide variety of fresh and unexpected flavors to the cones or edible containers themselves; and Second, by offering consumers the pleasure of enjoying a waffle cone in the form of something other than a cone, a bowl, a heart, a football. At present, waffle cones come in two flavors only: plain and chocolate. But with a wide variety of flavors, from fresh blueberries and bananas to Reese's Pieces® and Snickers®, the Method of Making A Waffle for use with ice-cream, frozen yogurt, and similar frozen desserts would open a new world to the waffle cone and be sure to please anyone's sweet-tooth. Thus, these unique waffle-cone creations—clever in conception, thoughtful and creative in development, and as delicious as the ice-cream or other desserts with which they would be filled—should find a wide and exceptionally enthusiastic market reception.

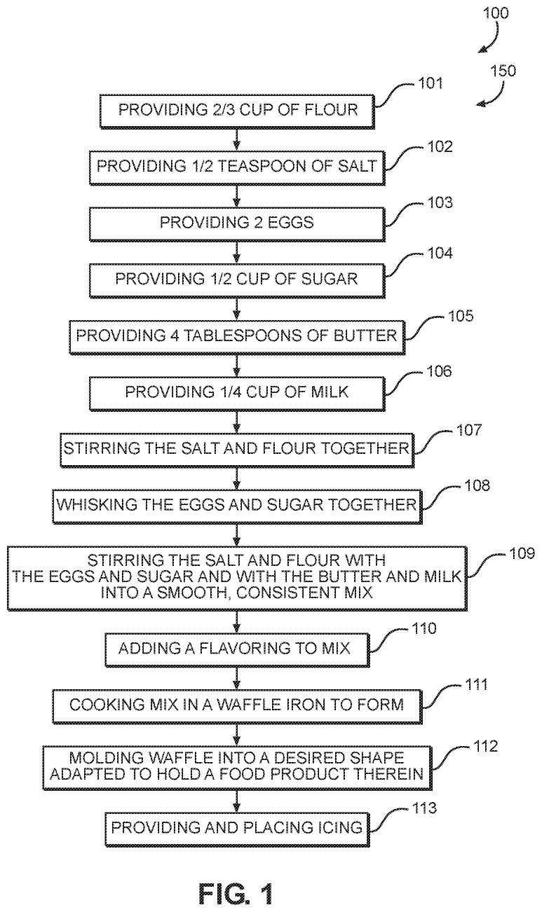

Referring to the drawings by numerals of reference there is shown in FIG. 1, showing flowchart 150 illustrating method 100 of making waffle 300 for use with ice-cream, frozen yogurt, and similar frozen desserts according to an embodiment of the present invention.

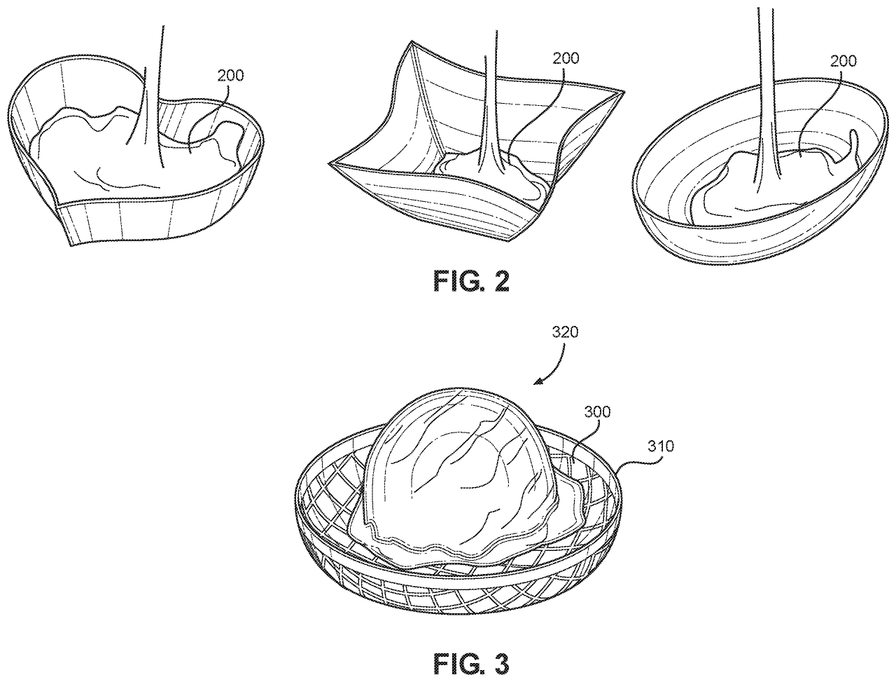

Method 100 of making waffle 300 comprising the steps of: step one 101 providing ⅔ cup of flour; step two 102 providing ½ teaspoon of salt; step three 103 providing 2 eggs; step four 104 providing ½ cup of sugar; step five 105 providing 4 tablespoons of butter; step six 106 providing ¼ cup of milk; step seven 107 stirring the salt and flour together; step eight 108 whisking the eggs and sugar together; step nine 109 stirring the salt and flour with the eggs and sugar and with the butter and milk into a smooth, consistent mix 200; step ten 110 adding a flavoring to mix 200; step eleven 111 cooking mix 200 in a waffle iron to form a waffle 300; and step twelve molding waffle 300 into a desired shape adapted to hold a food product therein as shown in FIG. 2.

Wherein the flavoring may include strawberries. Wherein the flavoring may include blueberries. Wherein the flavoring may include bananas. Wherein the flavoring may include walnuts. Wherein the flavoring may include cashews. Wherein the flavoring may include peanut butter. Wherein the flavoring may include vanilla. Wherein the flavoring may include chocolate. Wherein the flavoring may include a mix of chocolate and peanut butter. Wherein the flavoring is a mix of vanilla and chocolate.

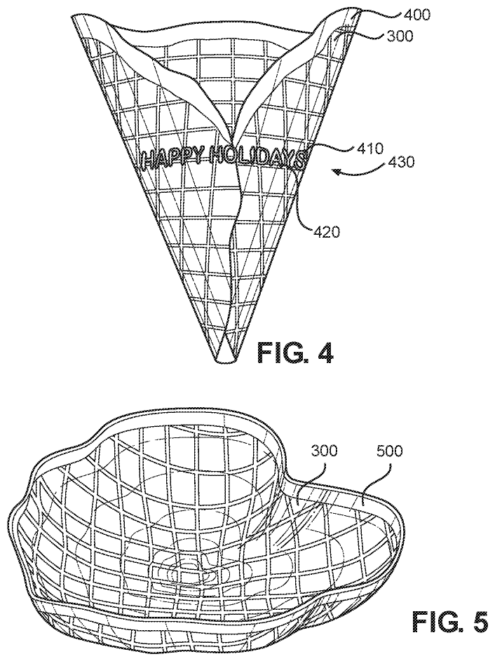

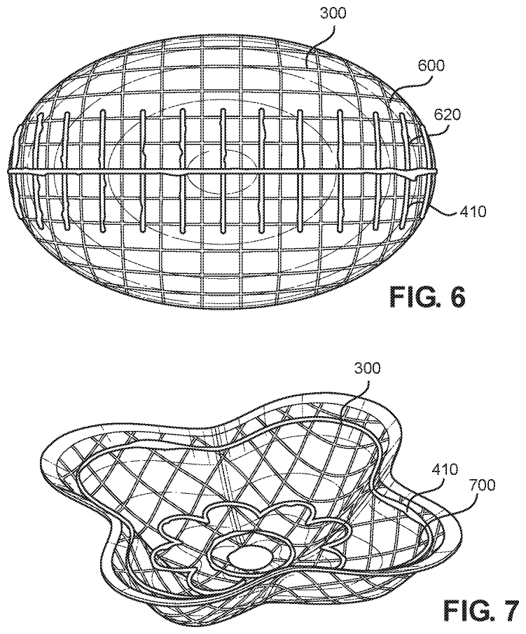

Referring now to FIGS. 2-7 showing perspective views illustrating various shapes of waffle 300 according to an embodiment of the present invention.

Wherein the shape is cone 400 as shown in FIG. 4. Wherein the shape is a football-shaped bowl 500 as shown in FIG. 6. Wherein the shape is heart-shaped bowl 500 as shown in FIG. 5. Wherein the shape is round-shaped bowl 310 as shown in in-use condition 320 of FIG. 3.

The method of making a waffle further comprising the step of thirteen 113 providing and placing icing 410 upon an outer surface of waffle 300 as shown in FIGS. 4, 6, and 7. Wherein step thirteen 113 of providing and placing icing 410 upon an outer surface of waffle 300 includes forming pattern 620 of icing 410 upon the outer surface of waffle 300 also shown in FIG. 6. Wherein step thirteen 113 of providing and placing icing 410 upon an outer surface of waffle 300 includes forming design 700 of icing 410 upon the outer surface of waffle 300 as shown in FIG. 7. Wherein step thirteen 113 of providing and placing icing 410 upon an outer surface of waffle 300 includes forming words 420 thereon as shown in FIG. 4.

It should be noted that step thirteen 113 is an optional step and may not be implemented in all cases. Optional steps of method 100 are illustrated using dotted lines in FIG. 1 so as to distinguish them from the other steps of method 100.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A method of making a waffle comprising the steps of:
providing ⅔ cup of flour;
providing ½ teaspoon of salt;
providing 2 eggs;
providing ½ cup of sugar;
providing 4 tablespoons of butter;
providing ¼ cup of milk;
stirring the salt and flour together;
whisking the eggs and sugar together;
stirring said salt and flour with said eggs and sugar and with said butter and milk into a smooth, consistent mix;
adding a flavoring to said mix;
cooking said mix in a waffle iron to form a waffle;
molding said waffle into a desired shape adapted to hold a food product therein.

2. The method of making a waffle of claim 1, wherein said flavoring is strawberries.

3. The method of making a waffle of claim 1, wherein said flavoring is blueberries.

4. The method of making a waffle of claim 1, wherein said flavoring is bananas.

5. The method of making a waffle of claim 1, wherein said flavoring is walnuts.

6. The method of making a waffle of claim 1, wherein said flavoring is cashews.

7. The method of making a waffle of claim 1, wherein said flavoring is peanut butter.

8. The method of making a waffle of claim 1, wherein said flavoring is vanilla.

9. The method of making a waffle of claim 1, wherein said flavoring is chocolate.

10. The method of making a waffle of claim 1, wherein said flavoring is a mix of chocolate and peanut butter.

11. The method of making a waffle of claim 1, wherein said flavoring is a mix of vanilla and chocolate.

12. The method of making a waffle of claim 1, wherein said shape is a cone.

13. The method of making a waffle of claim 1, wherein said shape is a football-shaped bowl.

14. The method of making a waffle of claim 1, wherein said shape is a heart-shaped bowl.

15. The method of making a waffle of claim 1, wherein said shape is a round-shaped bowl.

16. The method of making a waffle of claim 1, further comprising the step of providing and placing icing upon an outer surface of said waffle.

17. The method of making a waffle of claim 13, wherein said step of providing and placing icing upon an outer surface of said waffle includes forming a pattern of said icing upon said outer surface of said waffle.

18. The method of making a waffle of claim 13, wherein said step of providing and placing icing upon an outer surface of said waffle includes forming a design of said icing upon said outer surface of said waffle.

19. The method of making a waffle of claim 13, wherein said step of providing and placing icing upon an outer surface of said waffle includes forming words thereon.
